(19) United States
(12) Patent Application Publication
(10) Pub. No.: US 2024/0265292 A1
(43) Pub. Date: Aug. 8, 2024

(54) FAILURE PREDICTION AND REMEDIATION USING MACHINE LEARNING

(71) Applicant: Dell Products L.P., Round Rock, TX (US)

(72) Inventors: Parminder Singh Sethi, Ludhiana (IN); Manish Gupta, New Delhi (IN); Lakshmi Saroja Nalam, Bangalore (IN); Durai S. Singh, Bangalore (IN)

(21) Appl. No.: 18/106,146

(22) Filed: Feb. 6, 2023

(51) Int. Cl. G06N 20/00; G06N 5/022

(52) U.S. Cl. CPC G06N 20/00; G06N 5/022

(57) ABSTRACT

Techniques for failure prediction and remediation are disclosed. For example, a method comprises training one or more machine learning algorithms with a training dataset corresponding to a plurality of users, wherein the training dataset comprises at least one of product purchase data, product service data and product return data corresponding to the plurality of users. In the method, an input dataset corresponding to at least one user is received. The input dataset comprises at least one of product purchase data, product service data and product return data corresponding to the user. The input dataset is analyzed using the one or more machine learning algorithms. The method further comprises predicting, based at least in part on the analyzing, a likelihood of whether at least one product corresponding to the user will fail to be returned to a product providing entity when a return of the product has been requested.

### FIELD

The field relates generally to information processing systems, and more particularly to machine learning-based failure management in such information processing systems.

### BACKGROUND

Enterprises may authorize exchanges of devices and/or components when such devices and/or components malfunction or become inoperable. In several instances, however, the enterprise fails to receive the original products from the customers due to a variety of reasons. Current approaches are reactive to failures to return products, and are not capable of identifying when products may not be returned, thereby limiting an enterprise's ability to address and/or prevent such failures.

### SUMMARY

Embodiments provide a failure prediction and remediation platform in an information processing system.

For example, in one embodiment, a method comprises training one or more machine learning algorithms with a training dataset corresponding to a plurality of users, wherein the training dataset comprises at least one of product purchase data, product service data and product return data corresponding to the plurality of users. In the method, an input dataset corresponding to at least one user is received. The input dataset comprises at least one of product purchase data, product service data and product return data corresponding to the at least one user. The input dataset is analyzed using the one or more machine learning algorithms. The method further comprises predicting, based at least in part on the analyzing, a likelihood of whether at least one product corresponding to the at least one user will fail to be returned to a product providing entity when a return of the at least one product has been requested.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a failure prediction and remediation platform for predicting when products will fail to be returned and identifying priority for remediation in an illustrative embodiment.

FIG. 2 depicts customer data sources in an illustrative embodiment.

FIG. 3 depicts an operational flow for risk prediction and prioritization in an illustrative embodiment.

FIG. 4 depicts an architecture of a risk prediction engine in an illustrative embodiment.

FIG. 5A depicts a table of independent variables and data types used in connection with determining customer trust factors by linear regression in an illustrative embodiment.

FIG. 5B depicts a table of a dependent variable and data type corresponding to the use of linear regression to determine customer trust factors in an illustrative embodiment.

FIG. 6A depicts a table of independent variables and data types used in connection with identifying risk status by binary logistic regression in an illustrative embodiment.

FIG. 6B depicts a table of a dependent variable and data type corresponding to the use of binary logistic regression to identify risk status in an illustrative embodiment.

FIG. 7 depicts a table including a current state of fan failure and probabilities to transition to different states in an illustrative embodiment.

FIG. 8 is a flow diagram of an exemplary process for predicting when products will fail to be returned and identifying priority for remediation in an illustrative embodiment.

FIGS. 9 and 10 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

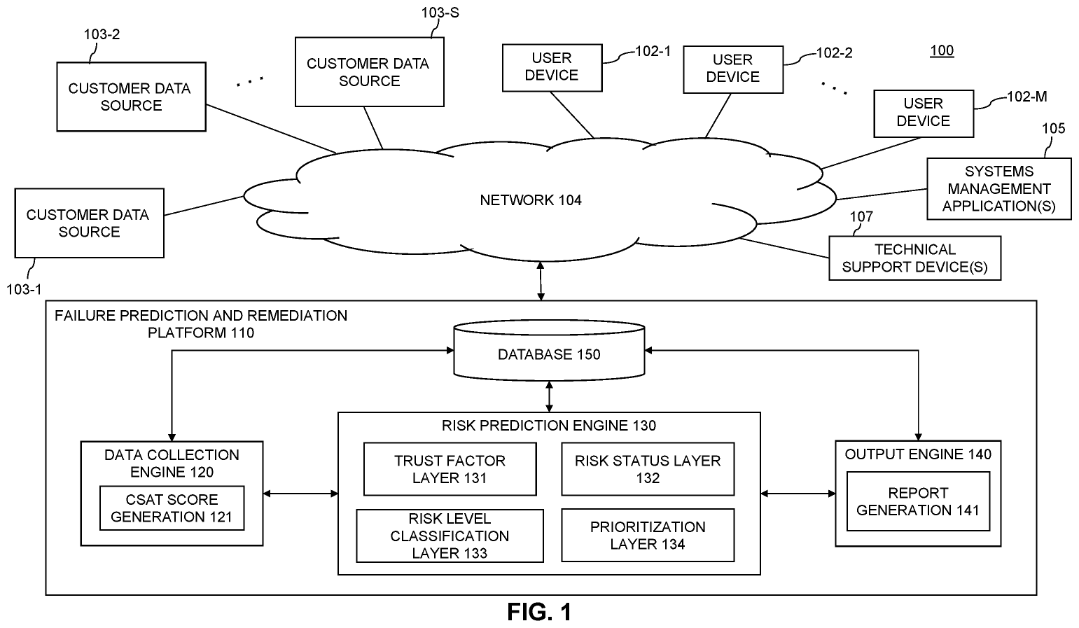

FIG. 1 shows an information processing system 100 configured in accordance with an illustrative embodiment. The information processing system 100 comprises user devices 102-1, 102-2, . . . 102-M (collectively “user devices 102”), one or more systems management applications 105 and one or more technical support devices 107. The user devices 102, systems management applications 105 and technical support devices 107 communicate over a network 104 with a failure prediction and remediation platform 110. The variable M and other similar index variables herein such as K, L and S are assumed to be arbitrary positive integers greater than or equal to one.

In a datacenter or other computing environment, systems management applications 105 monitor user devices 102 uninterruptedly and can provide remedial measures to address device and/or component issues identified in alerts received from the user devices 102. When an alert from a user device 102 is generated, the operational details of a faulty component may be collected by the systems management application 105 at the time of occurrence of the issue or failure of the component. A support case with this operational data and appropriate priority levels may be shared with technical support personnel via, for example, the one or more technical support devices 107.

The user devices 102, technical support devices 107 and devices on which the systems management applications 105 are executed comprise, for example, desktop, laptop or tablet computers, servers, host devices, storage devices, mobile telephones, Internet of Things (IoT) devices or other types of processing devices capable of communicating with the failure prediction and remediation platform 110 over the network 104. Such devices are examples of what are more generally referred to herein as “processing devices.” Some of these processing devices are also generally referred to herein as “computers.” The user devices 102, technical support devices 107 and devices on which the systems management applications 105 are executed may also or alternately comprise virtualized computing resources, such as virtual machines (VMs), containers, etc. The user devices 102, technical support devices 107 and devices on which the systems management applications 105 are executed in some embodiments comprise respective computers associated with a particular company, organization or other enterprise.

The terms “user,” “customer,” “client,” “personnel” or “administrator” herein are intended to be broadly construed so as to encompass numerous arrangements of human, hardware, software or firmware entities, as well as combinations of such entities. Failure prediction and remediation services may be provided for users utilizing one or more machine learning models, although it is to be appreciated that other types of infrastructure arrangements could be used. At least a portion of the available services and functionalities provided by the failure prediction and remediation platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the failure prediction and remediation platform 110, as well as to support communication between the failure prediction and remediation platform 110 and connected devices (e.g., user devices 102, technical support devices 107 and devices on which the systems management applications 105 are executed) and/or other related systems and devices not explicitly shown.

In some embodiments, the user devices 102, technical support devices 107 and/or devices on which the systems management applications 105 are executed are assumed to be associated with repair and/or support technicians, system administrators, information technology (IT) managers, software developers, release management personnel or other authorized personnel configured to access and utilize the failure prediction and remediation platform 110.

The failure prediction and remediation platform 110 in the present embodiment is assumed to be accessible to the user devices 102, technical support devices 107 and devices on which the systems management applications 105 are executed and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the failure prediction and remediation platform 110 includes a data collection engine 120, a risk prediction engine 130, an output engine 140 and a database 150. The data collection engine 120 includes a customer satisfaction (CSAT) score generation layer 121. The risk prediction engine 130 comprises a trust factor layer 131, a risk status layer 132, a risk level classification layer 133 and a prioritization layer 134. The output engine 140 comprises a report generation layer 141.

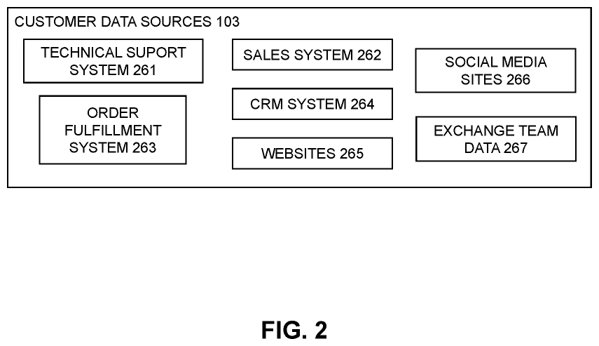

The data collection engine 120 collects customer data from one or more customer data sources 103-1, 103-2, . . . , 103-S (collectively “customer data sources 103”). Referring to FIG. 2, in a non-limiting illustrative embodiment, the customer data sources 103 comprise, for example, one or more of a technical support system 261, a sales system 262, an order fulfillment system 263 (e.g., supply chain), a customer relationship management (CRM) system 264, various websites 265, various social media sites 266 and exchange team data 267.

The data may be collected from the customer data sources 103 and/or from applications used for monitoring, mining and/or pulling data from the customer data sources 103. The customer data comprises, for example, data from a variety of operations (also referred to herein as “transactions”) including, but not necessarily limited to, product purchasing and procurement, product delivery, product returns and product service. The operations or transactions may correspond to a business enterprise or other product providing entity. The data collection engine 120 harvests the customer data from the customer data sources 103, and stores the harvested customer data in the database 150. In illustrative embodiments, harvesting the customer data from the customer data sources 103 comprises extracting features from the customer data such as, for example, customer, product, type of transaction, location, region, and/or operation outcomes (e.g., delay, damage, timely delivery, timely return, failure to return, etc.).

In illustrative embodiments, the data collection engine 120 performs data engineering and data pre-processing to identify the features and the corresponding data elements that will be influencing the predictions made by the risk prediction engine 130. In illustrative embodiments, the data engineering and data pre-processing includes generating multivariate plots and correlation heatmaps to identify the significance of each feature in the collected data, and filter less important data elements. The data engineering and data pre-processing reduces the dimensions and complexity of the machine learning algorithms, hence improving the accuracy and performance of the algorithms. In some embodiments, the data engineering and data pre-processing includes cleaning any unwanted characters and stop words from the customer data, and performing stemming and lemmatization, as well as changing text to lower case, removing punctuation, and removing incorrect or unnecessary characters. The processed and engineered data is stored in the database 150.

When a product (e.g., device or device component) of a product providing entity (e.g., business) fails, malfunctions or experiences some other unwanted issue, the product providing entity may attempt to troubleshoot the issue. If the issue cannot be resolved, the product providing entity may authorize an exchange after due diligence and a replacement product can be shipped to the customer. The expectation of the product providing entity is that the customer will return the originally received product, either before or after they receive the replacement product. Depending on the condition of the returned product, the product providing entity may put the product through a refurbishment process. The refurbished product may be sold via different channels based on its working condition. This enables the product providing entity to minimize revenue loss.

In several instances, the product providing entity fails to receive the exchanged product from the customer due to reasons such as customer failure, fraud, freight issues, scrapping, and so on. These unreturned products can be accounted for by the product providing entity as “write-offs.” Each year, product providing entities lose revenue worth several million dollars due to write-offs.

Illustrative embodiments provide a machine learning-based model to predict customers who may be associated with a failure to return products to a product providing entity. In some instances, the failure to return the products may be the fault of the customer (e.g., deliberate failure, intended fraud, etc.) or the result of unintended events (e.g., third-party fraud, freight issues, receiving issues, etc.). The embodiments advantageously permit exchange teams of product providing entities to proactively be alerted of customers associated with a risk of failure to return products prior to such failures, and follow-up with the customers to prevent the failures and to ensure that the products are returned.

A product providing entity may not receive a return product or receive a damaged product due to reasons such as, for example, customer failure (e.g., customer deliberately keeps an original product without returning it), fraud (e.g., impersonators request an exchange instead of the actual customer), freight issues (e.g., products lost and/or damaged in transit), direct scrapping (e.g., product is sent directly to another entity for scrapping or recycling), or receiving issues (e.g., failure to scan the returned product at a receiving hub).

As noted above, the customer data sources 103 comprise, for example, one or more of a technical support system 261, a sales system 262, an order fulfillment system 263, a CRM system 264, various websites 265, various social media sites 266 and exchange team data 267. In more detail, to predict customers who may be associated with a failure to return products, the machine learning algorithms of illustrative embodiments analyze multiple factors from data collected from the customer data sources 103. The data collected from the customer data sources 103 is further used to train the machine learning algorithms.

More specifically, the CSAT score generation layer 121 computes a CSAT score based on at least some factors from the data collected from the customer data sources 103. In illustrative embodiments, the CSAT score comprises a measure that indicates the level of satisfaction of a customer with products and/or services offered by a product providing entity. To measure the CSAT score, the CSAT score generation layer 121 employs linear regression techniques to analyze, for example, a number of service requests created for a product and/or customer in a given time period, duration taken to resolve relatively longer past issues (e.g., greater than a designated previous time period (>6 months ago, >1 year ago, >2 years ago, etc.)), duration to resolve more recent issues (e.g., less than a designated previous time period (<6 months ago, <1 year ago, <2 years ago, etc.)), operational data information for the product, and number of service requests for the product that have been reopened.

According to one or more embodiments, operational data (e.g., hardware component and firmware information) of the user devices 102 and/or components of the user devices 102 can be recorded automatically by the systems management applications 105 and/or the data collection engine 120. For example, the operational data can be recorded at pre-defined time intervals set by, for example, the systems management applications 105. The systems management applications 105 may comprise, for example, one or more data collection applications such as, but not necessarily limited to, SupportAssist Enterprise available from Dell Technologies. In illustrative embodiments, the systems management applications 105 and/or the data collection engine 120 collect operational data from the user devices 102 and/or components of the user devices 102 by tracking service requests, through scheduled collections at designated times and/or through event-based collections. In some embodiments, the data collection engine 120 receives pushed data or collects data from the user devices 102, components and/or the systems management applications 105.

When service requests for repair or to address issues corresponding to given ones of the user devices 102 or components of the user devices 102 are initiated, the systems management applications 105 and/or data collection engine 120 processes the service requests and collects operational data associated with the subject user device 102 and/or components of the user devices 102 identified in the service request. Scheduled collections occur at pre-defined times or intervals specified by, for example, a user via one or more user devices 102 or automatically scheduled by the systems management applications 105 and/or data collection engine 120. Event-based collections are triggered by one or more events such as, but necessarily limited to, component or device failure, a detected degradation of performance of a component or device, installation of new software or firmware, the occurrence of certain operations, etc. In some embodiments, an integrated Dell® remote access controller (iDRAC) causes the data collection engine 120 and/or systems management applications 105 to collect operational data from one or more user devices 102 and/or components and to export the collected data to a location (e.g., database or cache) on the failure prediction and remediation platform 110 or to a shared network location (e.g., centralized database). In some embodiments, the operational data is stored in a portion of the database 150.

In some situations, the operational data is supplied to support teams via one or more technical support devices 107. The operational data helps support personnel resolve issues by providing the support teams with collected logs describing the reason of failure in a particular component or in a user device 102 as a whole. The support teams and technical support devices 107 may be part of a technical support system 261.

The data collected from the customer data sources 103 further includes customer types, customer purchase and support profiles, customer demographics, customer social behavior, customer addresses, customer payment information, customer access information and customer write-off profiles, which can be retrieved from, for example, the technical support system 261, sales system 262, order fulfillment system 263, CRM system 264, websites 265, social media sites 266 and/or exchange team data 267. Customer type data includes, for example, information on the type of customer (e.g., large enterprise, small and midsize business (SMB), individual consumer, etc.). Customer purchase and support profile data includes information about, for example, customer product inquiries, customer behavior on commercial websites, and historical and current customer purchase patterns including, for example, types of products purchased, number of products purchased for each type, configurations of products purchased, and point-of-sale (POS) information (e.g., customer buying from a particular retailer/store/website, etc.). Customer demographics data includes, for example, customer region (e.g., North America, South America, Europe, Middle East and Africa (EMEA), Asia, Pacific and Japan (APJ) etc.), customer country, state and/or city, and historical data regarding whether customers from a particular area are known for and/or exhibit a pattern of not returning products. Customer social behavior data includes, for example, information on whether the customer has shared information on websites or social media platforms regarding how to defraud or get money back from businesses. Customer address data includes, for example, information on whether a dispatch address for a replacement product is different from the original shipping address, and information on a number of products not received from a particular address. Customer payment data includes, for example, information on customer payment methods that have been declined (e.g., by credit card companies due to fraud). Customer access data includes, for example, information on customers who are not reachable or difficult to contact via, for example, phone or email after they received an exchanged product. Customer write-off profile data includes, for example, historical data related to products that the customer has failed to return and needed to be written off by an entity.

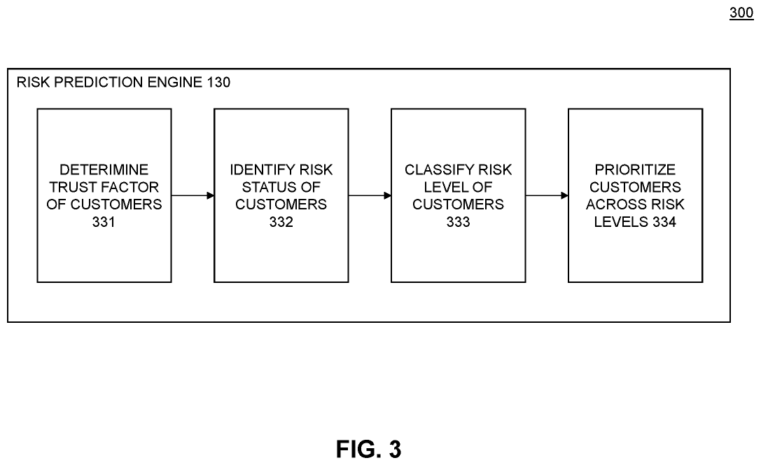

Referring to the operational flow 300 for operation of the risk prediction engine 130 in FIG. 3, historical data from a plurality of customer data sources 103 is used to train the machine learning models of the risk prediction engine 130 to determine a trust factor of customers 331, identify a risk status of customers 332, classify a risk level of customers 333 and prioritize customers across risk levels 334.

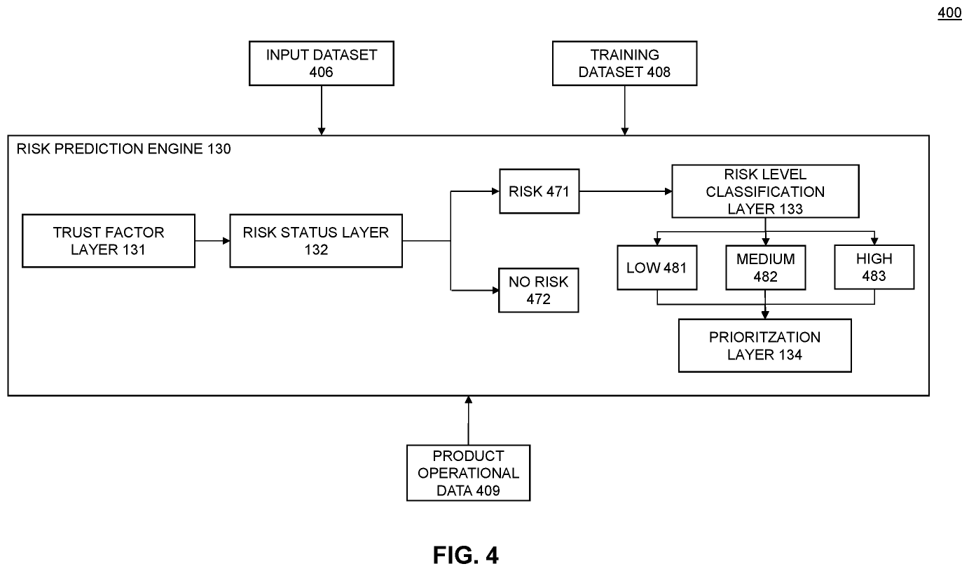

In illustrative embodiments, machine learning algorithms are trained with a training dataset corresponding to a plurality of users (e.g., customers). The training dataset comprises data from the customer data sources 103 such as, for example, product purchase data, product service data and/or product return data corresponding to the plurality of users. For example, referring to the architecture 400 in FIG. 4, the training dataset 408 is input to the risk prediction engine 130 following collection and processing by the data collection engine 120.

In connection with predicting a particular customer who may be associated with a failure to return one or more products to a product providing entity, an input dataset corresponding to at least one user (e.g., a customer) is received by the risk prediction engine 130. The input dataset comprises data from the customer data sources 103 such as, for example, product purchase data, product service data and/or product return data corresponding to the at least one user. For example, referring to the architecture 400 in FIG. 4, the input dataset 406 is input to the risk prediction engine 130 following collection and processing by the data collection engine 120.

The input dataset is analyzed by the risk prediction engine 130 using the trained machine learning algorithms. A likelihood of whether at least one product corresponding to the at least one user will fail to be returned is predicted based at least in part on the analyzing of the input dataset by the machine learning algorithms. For example, a likelihood of failure to return the product to a product providing entity when a return of the product has been requested is predicted.

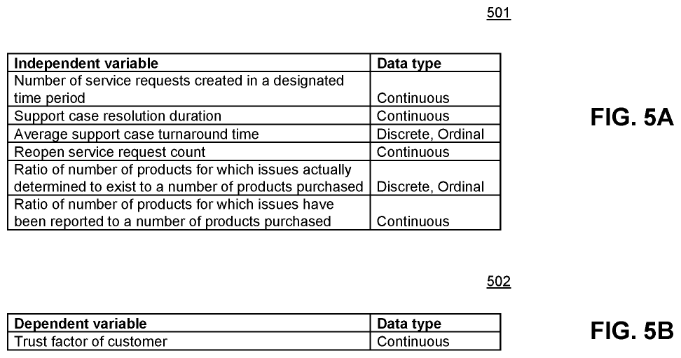

Referring to block 331 of FIG. 3, the trust factor layer 131 analyzes the input dataset 406 using a multiple linear regression machine learning algorithm to analyze one or more independent variables to determine a trust factor of the at least one user (e.g., customer). Referring, for example, to the table 501 in FIG. 5A, the one or more independent variables comprise, for example, a number of service requests created for at least one of the at least one product and the at least one user in a designated time period (within past week, 2 weeks, month, 3 months, 6 months, etc.), a number of service requests for at least one of the at least one product and the at least one user that have been reopened, and/or a ratio of a number of products for which issues have been reported by the at least one user to a number of products purchased by the at least one user. Referring, for example, to the table 501 in FIG. 5A, the one or more independent variables may also comprise, for example, support case resolution duration (e.g., for recently closed cases, where recently closed corresponds to cases closed within a threshold time period (1 week ago, 2 weeks ago, 1 month ago, etc.)), average support case turnaround time, and a ratio of number of products for which issues actually determined to exist to a number of products purchased. As can be seen in the table 502 in FIG. 5B, the dependent variable for the multiple linear regression performed by the trust factor layer 131 is a trust factor of the customer. In addition, as can be seen in FIGS. 5A and 5B, the data types for the independent and dependent variables are continuous, discrete and/or ordinal.

The trust factor layer 131 of the customer is computed in accordance with the following equation (1):

$$y = {β}_{0} + {β}_{1} {x}_{1} + {β}_{2} {x}_{2} + ... . {β}_{p} {x}_{p} + ε \qquad ( 1 )$$

where y is the trust factor of the customer, δ is the intercept, x is the independent variables and ε is the error. P corresponds to an integer greater than or equal to 1 depending on the number of independent variables.

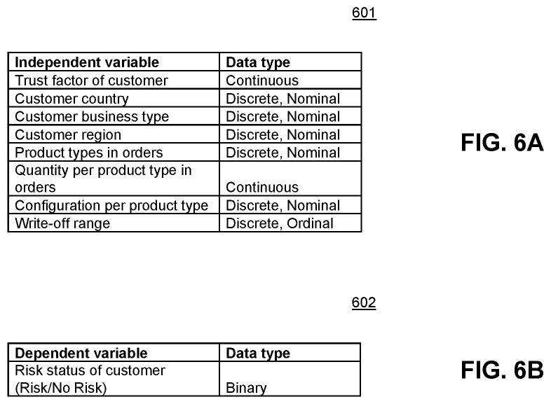

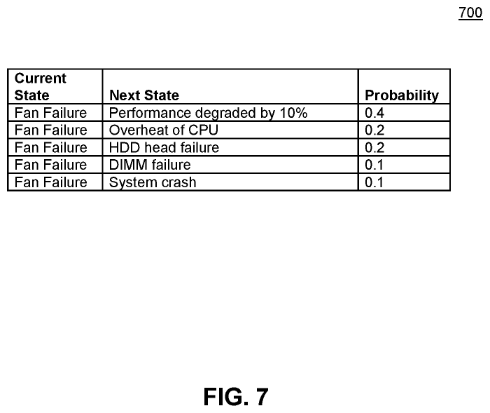

Referring to block 332 of FIG. 3, the risk status layer 132 analyzes the input dataset 406 using a binary logistic regression machine learning algorithm to analyze one or more independent variables to determine whether the at least one user (e.g., customer) corresponds to a risk that the at least one product will fail to be returned to the product providing entity. For example, referring to FIG. 4, the output from the risk status layer 132 is one of a binary output of risk 471 or no risk 472. Referring, for example, to the table 601 in FIG. 6A, the one or more independent variables comprise, for example, a trust factor of the at least one user (e.g., computed by the trust factor layer 131), a geographic location associated with the at least one user (e.g., North America, South America, EMEA, APJ, country, state and/or city), a type of the at least one user (e.g., large enterprise, SMB, individual consumer, etc.), one or more product types associated with the at least one user in one or more orders, respective numbers of the one or more product types in one or more orders associated with the at least one user, respective configurations of the one or more product types and write-off range associated with the at least one user. As can be seen in the table 602 in FIG. 6B, the dependent variable for the binary logistic regression performed by the risk status layer 132 is one of a binary output of risk status of the customer (Risk/No Risk). In addition, as can be seen in FIGS. 6A and 6B, the data types for the independent variables are continuous, discrete and/or ordinal, and a data type of the dependent variable is binary.

Referring to block 333 of FIG. 3 and to the architecture 400 of FIG. 4, if the risk status is Risk 471, the risk level classification layer 133 classifies a risk level to which the at least one user corresponds. For example, the risk level can be low 481, medium 482 or high 483. In an illustrative embodiment, the classification is performed using a k-nearest neighbor (KNN) machine learning algorithm, which is a supervised learning algorithm that can be used for classification and regression predictive problems. Steps for training a machine learning model using KNN include: (i) selecting a number k for the number of neighbors (e.g., k=3); (ii) computing the Euclidean distance of k number of neighbors; (iii) taking the k-nearest neighbors as per the computed Euclidean distance; (iv) among the k neighbors, computing the number of data points in each category; and (v) where the number of neighbors is maximum, assigning a new data point to that category.

Referring to block 334 of FIG. 3 and to the architecture 400 of FIG. 4, the prioritization layer 134 receives data corresponding to operation of at least one product (e.g., product operation data 409). In illustrative embodiments, the product comprises a device and/or a device component, and the data corresponding to the operation of the at least one product comprises an operational state the product. The prioritization layer 134 uses one or more machine learning algorithms to predict one or more future operational states of the at least one product based, at least in part, on the data corresponding to the operation of the at least one product. In some instances, the product operational data 409 may include one or more alerts about the functioning of the product indicating an issue with the operation of the product.

In illustrative embodiments, the product operational data 409 comprises state information of the user devices 102 and components, and comprises data from one or more logs. The data and logs include, but are not necessarily limited to, server logs, OS utilization data, server hardware configuration data, OS event logs, debug logs, application data and storage logs. The operational data, including the data in the logs, can be collated. For example, in illustrative embodiments, the data is collated based on changes in the operational states of the user devices 102 and/or components, durations of the operational states before changing to a different operational state and/or whether the changes in the operational states resulted in failure of the user devices 102 and/or components. The data is also collated based on device type, device component type, alerts indicating one or more issues with the user devices 102 and/or components and/or severity of the alerts.

The product operational data 409 including logs for various device and component operations is collected by the systems management applications 105 and/or the data collection engine 120, for example, at periodic intervals, in connection with support tickets and/or when requested by a user (e.g., technical support personnel). The collected data provides details of the states of user devices 102 and components over different time periods. The data sets when collated, provide present operational states, operational states that the user devices 102 and/or components have transitioned to (e.g., before and during resolution of a support ticket), and the duration to transition to the other states. In illustrative embodiments, the training dataset 408 can include historical product operational data providing the details of the states of user devices 102 and components over different time periods, including operational states that the user devices 102 and/or components have transitioned to (e.g., before and during resolution of a support ticket), and the duration to transition to the other states. The one or more machine learning algorithms used by the prioritization layer 134 are trained with the historical operational data corresponding to the changes in operational states for respective ones of a plurality of products.

In illustrative embodiments, based on received state data of a given product, the prioritization layer 134 uses machine learning to predict one or more probabilities of respective ones of the one or more future operational states of the given product. The predicting of the one or more probabilities of the respective ones of the one or more future operational states is performed using a stochastic model.

For example, the table 700 provides an example of probabilities to transition to different states from a current state of fan failure. As can be seen, the predicted probability to transition from fan failure to performance being degraded by 10% is 0.4 (e.g., 40%), the predicted probability to transition from fan failure to overheating of the central processing unit (CPU) is 0.2 (e.g., 20%), the predicted probability to transition from fan failure to hard disk drive (HDD) failure is 0.2 (e.g., 20%), the predicted probability to transition from fan failure to dual in-line memory module (DIMM) failure is 0.1 (e.g., 10%) and the predicted probability to transition from fan failure to a system crash is 0.1 (10%).

An example of the transition states of a device due to, for example, fan failure is as follows:
Fan failure→Overheat of CPU→CPU failure→System crash
Fan failure→Performance degraded by 10%
Fan failure→DIMM failure→System crash
Fan failure→Overheat of CPU→HDD head failure
Fan failure→System crash
Fan failure→HDD head failure→RAID group failure→System crash
Fan failure→HDD head failure→System crash

After the transition states are determined, the embodiments employ a stochastic model (e.g., Markov chain techniques) to derive the probability of transition to the next state. The prioritization layer 134 predicts probabilities of future operational states of the user devices 102 and/or components using the stochastic model. The prediction of the probabilities of the future operational states is based on the most recently known operational states of the user devices 102 and/or components. In illustrative embodiments, a machine learning algorithm trained with at least a portion of the collated data as described herein predicts the probability of the future device and component states. The prediction is dependent on a current device or component state (e.g., most recent state known to the machine learning algorithm). In a non-limiting illustrative embodiment, a Markov chain model is used to predict future state probabilities. Markov chain analysis uses a current state to predict a next state, and does not consider states prior to the current state or how the current state was reached.

In an operational example using Markov analysis, when an alert is received by a faulty one of the components or user devices 102, the future state is predicted without depending on the details on how the component or user device 102 reached its present state. In an illustrative embodiment, to determine the probabilities of the next component or device states, a transition matrix in accordance with the Markov chain may be generated. The matrix can include rows corresponding to current device or component states (e.g., most recent known operational states) at times t and columns corresponding to the future device or component states at times t+1. The probabilities of the device or component states comprise the entries on the matrix. The rows in the matrix (current state (“Now”)) add up to 1, and the columns in the matrix (future state (“Next”)) also add up to 1.

Once the probability is determined, the embodiments use conformal prediction (e.g., Mondrian conformal prediction) and ranking to determine the next state with confidence. The predictions with a confidence level are based on the respective probabilities of the future operational states. In applying the conformal prediction model, a random forest model may be used to compute a conformity value of the respective probabilities of the future operational states.

Depending on the criticality of a next state of a user device 102 or component, the customers will be prioritized within each risk level. For example, higher criticality of a next state will lead to an increase in priority or risk level for a customer already determined to be a risk. The prioritization helps to ensure customers return a product, for example, when a product providing entity has authorized an exchange, and a risk level of the customer has been determined, or when a customer has not requested an exchange, but the prioritization layer 134 has determined that the product or a related component could fail. In this case, the product providing entity can proactively request that the customer return the product for a fix prior to failure of the product.

This prioritized risk profile of customers is provided to, for example, an exchange collections team for proactive and intensive follow up with such customers until a product is returned. This enables the product providing entity to receive the product from the customer and thereby reduce the number of products that would otherwise be accounted for as a loss. A report generation layer 141 of the output engine 140 generates a report of the prioritized risk profile of customers based on the analysis by the risk prediction engine 130, and causes transmission over network 104 of the prioritized risk profile to one or more user devices 102 associated with, for example, an exchange collections team. In one or more embodiments, upon receipt of the prioritized risk profile of customers, the user devices 102 automatically implement customer contact steps that can be performed by automated means such as, for example, initiating telephone calls or emails about products that need to be returned.

According to one or more embodiments, the database 150 and other data repositories or databases referred to herein can be configured according to a relational database management system (RDBMS) (e.g., PostgreSQL). In some embodiments, the database 150 and other data repositories or databases referred to herein are implemented using one or more storage systems or devices associated with the failure prediction and remediation platform 110. In some embodiments, one or more of the storage systems utilized to implement the database 150 and other data repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the failure prediction and remediation platform 110, the data collection engine 120, risk prediction engine 130, output engine 140 and/or database 150 in other embodiments can be implemented at least in part externally to the failure prediction and remediation platform 110, for example, as stand-alone servers, sets of servers or other types of systems coupled to the network 104. For example, the data collection engine 120, risk prediction engine 130, output engine 140 and/or database 150 may be provided as cloud services accessible by the failure prediction and remediation platform 110.

The data collection engine 120, risk prediction engine 130, output engine 140 and/or database 150 in the FIG. 1 embodiment are each assumed to be implemented using at least one processing device. Each such processing device generally comprises at least one processor and an associated memory, and implements one or more functional modules for controlling certain features of the data collection engine 120, risk prediction engine 130, output engine 140 and/or database 150.

At least portions of the failure prediction and remediation platform 110 and the elements thereof may be implemented at least in part in the form of software that is stored in memory and executed by a processor. The failure prediction and remediation platform 110 and the elements thereof comprise further hardware and software required for running the failure prediction and remediation platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, risk prediction engine 130, output engine 140, database 150 and other elements of the failure prediction and remediation platform 110 in the present embodiment are shown as part of the failure prediction and remediation platform 110, at least a portion of the data collection engine 120, risk prediction engine 130, output engine 140, database 150 and other elements of the failure prediction and remediation platform 110 in other embodiments may be implemented on one or more other processing platforms that are accessible to the failure prediction and remediation platform 110 over one or more networks. Such elements can each be implemented at least in part within another system element or at least in part utilizing one or more stand-alone elements coupled to the network 104.

It is assumed that the failure prediction and remediation platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, risk prediction engine 130, output engine 140, database 150 and other elements of the failure prediction and remediation platform 110, and the elements thereof can each be implemented in the form of one or more LXCs running on one or more VMs. Other arrangements of one or more processing devices of a processing platform can be used to implement the data collection engine 120, risk prediction engine 130, output engine 140 and database 150, as well as other elements of the failure prediction and remediation platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the failure prediction and remediation platform 110 to reside in different data centers. Numerous other distributed implementations of the failure prediction and remediation platform 110 are possible.

Accordingly, one or each of the data collection engine 120, risk prediction engine 130, output engine 140, database 150 and other elements of the failure prediction and remediation platform 110 can each be implemented in a distributed manner so as to comprise a plurality of distributed elements implemented on respective ones of a plurality of compute nodes of the failure prediction and remediation platform 110.

It is to be appreciated that these and other features of illustrative embodiments are presented by way of example only, and should not be construed as limiting in any way. Accordingly, different numbers, types and arrangements of system elements such as the data collection engine 120, risk prediction engine 130, output engine 140, database 150 and other elements of the failure prediction and remediation platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the failure prediction and remediation platform can be offered to cloud infrastructure customers or other users as part of FaaS, CaaS and/or PaaS offerings.

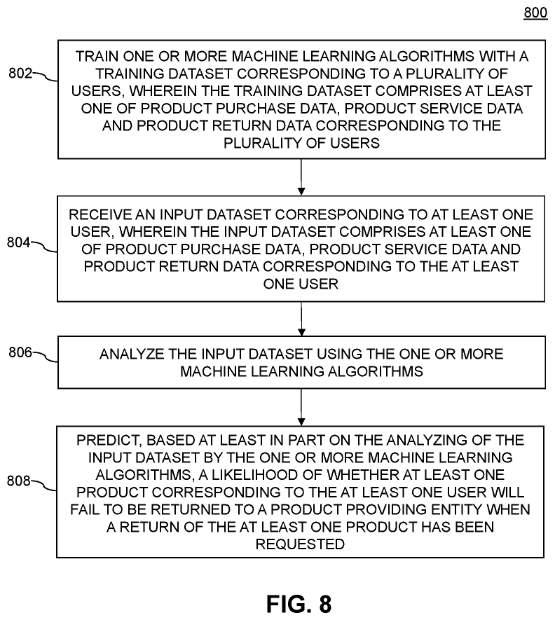

The operation of the information processing system 100 will now be described in further detail with reference to the flow diagram of FIG. 8. With reference to FIG. 8, a process 800 for failure prediction and remediation as shown includes steps 802 through 808, and is suitable for use in the system 100 but is more generally applicable to other types of information processing systems comprising a failure prediction and remediation platform configured for predicting when products will fail to be returned and identifying priority for remediation.

In step 802, one or more machine learning algorithms are trained with a training dataset corresponding to a plurality of users. The training dataset comprises at least one of product purchase data, product service data and product return data corresponding to the plurality of users.

In step 804, an input dataset corresponding to at least one user is received. The input dataset comprises at least one of product purchase data, product service data and product return data corresponding to the at least one user.

In step 806, the input dataset is analyzed using the one or more machine learning algorithms. Step 808 comprises predicting, based at least in part on the analyzing of the input dataset by the one or more machine learning algorithms, a likelihood of whether at least one product corresponding to the at least one user will fail to be returned to a product providing entity when a return of the at least one product has been requested.

In illustrative embodiments, the method also includes receiving data corresponding to operation of the at least one product. The at least one product comprises at least one of a device and a device component, and the data corresponding to the operation of the at least one product comprises an operational state the at least one product. Using the one or more machine learning algorithms, one or more future operational states of the at least one product are predicted based, at least in part, on the data corresponding to the operation of the at least one product. In addition, using the one or more machine learning algorithms, one or more probabilities of respective ones of the one or more future operational states of the at least one product are predicted. The predicting of the one or more probabilities of the respective ones of the one or more future operational states is performed using a stochastic model. The predicting of the one or more future operational states of the at least one product comprises using a conformal prediction model to predict the one or more future operational states with a confidence level based on the one or more probabilities. A priority is assigned to the at least one product and to the at least one user based at least in part on the one or more future operational states of the at least one product.

According to an illustrative embodiment, the one or more machine learning algorithms are trained with an additional training dataset comprising data corresponding to operation of a plurality of products. The plurality of products comprise at least one of a plurality of devices and a plurality of device components, and the data corresponding to the operation of the plurality of products comprises one or more changes in operational states for respective ones of the plurality of products.

The analyzing of the input dataset comprises using multiple linear regression to analyze one or more independent variables to determine a trust factor of the at least one user. In this case, the one or more independent variables comprise at least one of a number of service requests created for at least one of the at least one product and the at least one user in a designated time period, a number of service requests for at least one of the at least one product and the at least one user that have been reopened, and a ratio of a number of products for which issues have been reported by the at least one user to a number of products purchased by the at least one user.

The analyzing of the input dataset also comprises using binary logistic regression to analyze one or more independent variables to determine whether the at least one user corresponds to a risk that the at least one product will fail to be returned to the product providing entity. In this case, the one or more independent variables comprise at least one of a trust factor of the at least one user, a geographic location associated with the at least one user, a type of the at least one user, one or more product types associated with the at least one user, respective numbers of the one or more product types in one or more orders associated with the at least one user, and respective configurations of the one or more product types.

The analyzing of the input dataset further comprises classifying a risk level to which the at least one user corresponds in response to a determination that the at least one user corresponds to a risk. The one or more machine learning algorithms perform the classifying and comprise a supervised learning algorithm. The supervised learning algorithm comprises KNN algorithm.

It is to be appreciated that the FIG. 8 process and other features and functionality described above can be adapted for use with other types of information systems configured to execute failure prediction and remediation services in a failure prediction and remediation platform or other type of platform.

The particular processing operations and other system functionality described in conjunction with the flow diagram of FIG. 8 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 8 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a failure prediction and remediation platform as disclosed herein can provide a number of significant advantages relative to conventional arrangements. For example, the failure prediction and remediation platform effectively uses machine learning techniques to proactively predict customer purchases that could lead to write-offs for a business due to a failure to return products. As an additional advantage, the embodiments advantageously use machine learning techniques to categorize customers at different levels of write-off risks (e.g., high, medium, and low risk) based on customer data and product operational data.

The embodiments further provide technical solutions that use machine learning to predict future states of devices and components, which may lead to system failure. As an additional advantage, the embodiments provide techniques for using a stochastic model to predict, with minimal turnaround time, probabilities of future states. Based on the probabilities, conformal prediction techniques are leveraged to ascertain a next state a device or component would transition to from a current state if an issue is not resolved. At this stage a more accurate set of future device states is obtained. The embodiments assign higher priority to customers corresponding to devices or components with predicted future operational states that may result in device or system failure. As a result, the embodiments enable more efficient management and tracking of the return of products, as well as targeted and focused follow-up with potential defaulters or risk-prone clientele. By proactively identifying customers associated with a likelihood of failure to return products, the embodiments lead to increased returns and the ability to re-use or refurbish returned products, thereby conserving valuable natural resources and materials.

The embodiments further advantageously use machine learning algorithms to evaluate operational data to predict device and component states. Unlike conventional techniques, the embodiments provide a framework for proactively predicting and alerting enterprise of upcoming component and device states by analyzing current and previous states in operational logs. As an additional advantage, unlike current approaches, once an accurate set of future device or component states is obtained, the embodiments provide technical solutions prioritize customers associated with critical future states and streamline steps to contact such customers for product returns. As a result, timely action can be taken to prevent unwanted or catastrophic failure or degradation of devices and components.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the failure prediction and remediation platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a failure prediction and remediation platform in illustrative embodiments. These and other cloud-based systems in illustrative embodiments can include object stores.

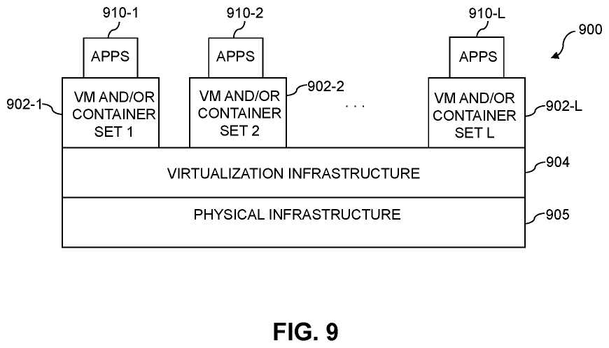

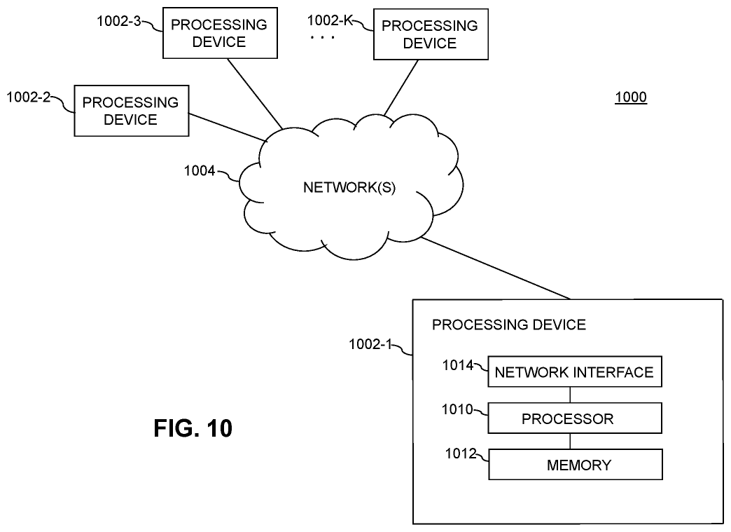

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1002-1 in the processing platform 1000 comprises a processor 1010 coupled to a memory 1012. The processor 1010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1012 may comprise random access memory (RAM), read-only memory (ROM), flash memory or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the failure prediction and remediation platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and failure prediction and remediation platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
training one or more machine learning algorithms with a training dataset corresponding to a plurality of users, wherein the training dataset comprises at least one of product purchase data, product service data and product return data corresponding to the plurality of users;
receiving an input dataset corresponding to at least one user, wherein the input dataset comprises at least one of product purchase data, product service data and product return data corresponding to the at least one user;
analyzing the input dataset using the one or more machine learning algorithms; and
predicting, based at least in part on the analyzing of the input dataset by the one or more machine learning algorithms, a likelihood of whether at least one product corresponding to the at least one user will fail to be returned to a product providing entity when a return of the at least one product has been requested;
wherein the steps of the method are executed by a processing device operatively coupled to a memory.

2. The method of claim 1 further comprising:
receiving data corresponding to operation of the at least one product, wherein the at least one product comprises at least one of a device and a device component, and wherein the data corresponding to the operation of the at least one product comprises an operational state the at least one product;
predicting, using the one or more machine learning algorithms, one or more future operational states of the at least one product based, at least in part, on the data corresponding to the operation of the at least one product.

3. The method of claim 2 further comprising predicting, using the one or more machine learning algorithms, one or more probabilities of respective ones of the one or more future operational states of the at least one product.

4. The method of claim 3 wherein the predicting of the one or more probabilities of the respective ones of the one or more future operational states is performed using a stochastic model.

5. The method of claim 3 wherein the predicting of the one or more future operational states of the at least one product comprises using a conformal prediction model to predict the one or more future operational states with a confidence level based on the one or more probabilities.

6. The method of claim 2 further comprising training the one or more machine learning algorithms with an additional training dataset comprising data corresponding to operation of a plurality of products, wherein the plurality of products comprise at least one of a plurality of devices and a plurality of device components, and wherein the data corresponding to the operation of the plurality of products comprises one or more changes in operational states for respective ones of the plurality of products.

7. The method of claim 2 further comprising assigning a priority to the at least one product and to the at least one user based at least in part on the one or more future operational states of the at least one product.

8. The method of claim 1 wherein the analyzing of the input dataset comprises using multiple linear regression to analyze one or more independent variables to determine a trust factor of the at least one user.

9. The method of claim 8 wherein the one or more independent variables comprise at least one of a number of service requests created for at least one of the at least one product and the at least one user in a designated time period, a number of service requests for at least one of the at least one product and the at least one user that have been reopened, and a ratio of a number of products for which issues have been reported by the at least one user to a number of products purchased by the at least one user.

10. The method of claim 1 wherein the analyzing of the input dataset comprises using binary logistic regression to analyze one or more independent variables to determine whether the at least one user corresponds to a risk that the at least one product will fail to be returned to the product providing entity.

11. The method of claim 10 wherein the one or more independent variables comprise at least one of a trust factor of the at least one user, a geographic location associated with the at least one user, a type of the at least one user, one or more product types associated with the at least one user, respective numbers of the one or more product types in one or more orders associated with the at least one user, and respective configurations of the one or more product types.

12. The method of claim 10 wherein the analyzing of the input dataset further comprises classifying a risk level to which the at least one user corresponds in response to an affirmative determination, wherein the one or more machine learning algorithms perform the classifying and comprise a supervised learning algorithm.

13. The method of claim 12 wherein the supervised learning algorithm comprises k-nearest neighbor algorithm.

14. An apparatus comprising:
a processing device operatively coupled to a memory and configured:
to train one or more machine learning algorithms with a training dataset corresponding to a plurality of users, wherein the training dataset comprises at least one of product purchase data, product service data and product return data corresponding to the plurality of users;
to receive an input dataset corresponding to at least one user, wherein the input dataset comprises at least one of product purchase data, product service data and product return data corresponding to the at least one user;
to analyze the input dataset using the one or more machine learning algorithms; and
to predict, based at least in part on the analyzing of the input dataset by the one or more machine learning algorithms, a likelihood of whether at least one product corresponding to the at least one user will fail to be returned to a product providing entity when a return of the at least one product has been requested.

15. The apparatus of claim 14 wherein, in analyzing the input dataset, the processing device is configured to use multiple linear regression to analyze one or more independent variables to determine a trust factor of the at least one user.

16. The apparatus of claim 14 wherein, in analyzing the input dataset, the processing device is configured to use binary logistic regression to analyze one or more independent variables to determine whether the at least one user corresponds to a risk that the at least one product will fail to be returned to the product providing entity.

17. The apparatus of claim 16 wherein, in analyzing the input dataset, the processing device is further configured to classify a risk level to which the at least one user corresponds in response to an affirmative determination, wherein the one or more machine learning algorithms perform the classifying and comprise a supervised learning algorithm.

18. An article of manufacture comprising a non-transitory processor-readable storage medium having stored therein program code of one or more software programs, wherein the program code when executed by at least one processing device causes said at least one processing device to perform the steps of:
training one or more machine learning algorithms with a training dataset corresponding to a plurality of users, wherein the training dataset comprises at least one of product purchase data, product service data and product return data corresponding to the plurality of users;
receiving an input dataset corresponding to at least one user, wherein the input dataset comprises at least one of product purchase data, product service data and product return data corresponding to the at least one user;
analyzing the input dataset using the one or more machine learning algorithms; and
predicting, based at least in part on the analyzing of the input dataset by the one or more machine learning algorithms, a likelihood of whether at least one product corresponding to the at least one user will fail to be returned to a product providing entity when a return of the at least one product has been requested.

19. The article of manufacture of claim 18 wherein, in analyzing the input dataset, the program code causes said at least one processing device to use multiple linear regression to analyze one or more independent variables to determine a trust factor of the at least one user.

20. The article of manufacture of claim 18 wherein, in analyzing the input dataset, the program code causes said at least one processing device to use binary logistic regression to analyze one or more independent variables to determine whether the at least one user corresponds to a risk that the at least one product will fail to be returned to the product providing entity.
